(19) United States
(12) Patent Application Publication
(10) Pub. No.: US 2007/0024080 A1
(43) Pub. Date: Feb. 1, 2007

(54) Assembly comprised of a vehicle folding top and a roller blind

(75) Inventors: Rainer Grimm, Frankfurt (DE); Thomas Becher, Rodgau (DE); Joachim Roeder, Muehlheim (DE); Horst Boehm, Frankfurt (DE)

Correspondence Address: CARLSON, GASKEY & OLDS, P.C., 400 WEST MAPLE ROAD, SUITE 350, BIRMINGHAM, MI, 48009, US

(73) Assignee: ArvinMeritor GmbH

(21) Appl. No.: 11/481,455

(22) Filed: Jul. 6, 2006

(30) Foreign Application Priority Data
Jul. 27, 2005 (EP) 05 016 283.3

(51) Int. Cl. B60J 7/02

(52) U.S. Cl. 296/107.13

(57) ABSTRACT

An assembly includes a vehicle folding top that can cover or expose a roof opening, and a roller blind that is arranged beneath the folding top when in a closed condition. The roller blind can fully or partly cover the roof opening exposed by the folding top.

### RELATED APPLICATIONS

The application claims priority to European Patent Application No. 05 016 283.3, which was filed on Jul. 27, 2005.

### BACKGROUND OF THE INVENTION

The present invention relates to an assembly comprised of a vehicle folding top and a roller blind.

Aside from an outer skin that is visible from outside a vehicle, a conventional folding top has an inner lining that provides a visually appealing impression, and which covers a linkage of the folding top. The visual appearance of the inner lining may be matched with a remaining inner lining of the vehicle. The production of folding tops of this type, however, is complicated and expensive.

It is an object of the invention to reduce the costs of a folding top.

### SUMMARY OF THE INVENTION

This objective is accomplished by providing an assembly that includes a vehicle folding top that can cover or expose a roof opening, and a roller blind which is arranged beneath the vehicle folding top when in a closed condition. The roller blind can fully or partly cover the roof opening exposed by the vehicle folding top. Since an inner side of the vehicle folding top, as viewed from an interior of a vehicle, is covered up by the roller blind, the folding top need not be provided with an expensive lining on the inside. In addition, a gain in functionality is achieved because the roller blind may be used as an additional sunshade or windbreak, for example.

Preferably, the roller blind constitutes an inner lining for the vehicle folding top so that, in order to save costs, the vehicle folding top itself may be configured without an integrated inner lining.

An inner side of the vehicle folding top, as viewed from the interior of the vehicle, is preferably always covered up by the roller blind. In this way, the inner side of the vehicle folding top, which need not satisfy any high requirements as to appearance, is never visible from the vehicle interior.

Advantageously, a front edge of the roller blind facing a vehicle front is always at least at a same level with a front edge of the vehicle folding top. However, the roller blind can be adapted to be shifted independently of the vehicle folding top across an area of the roof opening that is not covered by the vehicle folding top. This allows a vehicle occupant to use the roller blind as a sunshade or windbreak for an exposed part of the roof opening as desired and independently of the position of the vehicle folding top.

When the vehicle folding top is moved for closure, the roller blind is advantageously and preferably always moved along as soon as a front edge of the vehicle folding top has reached a front edge of the roller blind in a closing direction. In this way, no unintentional exposure of the inner side of the vehicle folding top can occur.

The vehicle folding top and the roller blind are preferably movable by at least one electric drive. Additionally or alternatively, a second drive or a manual control may be provided for the roller blind or for the vehicle folding top as well.

The roof opening preferably extends substantially as far as a lower end of a rear column of the vehicle. This means that the vehicle has no positionally fixed rear window.

When the vehicle folding top is in a folded condition, the vehicle folding top together with a spindle of the roller blind can preferably be moved between first and second positions, the folded folding top and the spindle of the roller blind being situated at an upper end of the rear window in the first position and behind a backrest of a vehicle seat in the second position.

This arrangement offers the advantage that the roller blind may also be positioned to serve as a wind deflector, while the vehicle folding top can remain in the second position, thus taking on a third function.

Preferably, the vehicle folding top is guided in a pair of parallel rails oriented in a longitudinal direction of the vehicle, as is known from the prior art, with the vehicle folding top and the roller blind preferably running in separate guides. The roller blind may, for instance, run in a lateral guide.

These and other features of the present invention can be best understood from the following specification and drawings, the following of which is a brief description.

### BRIEF DESCRIPTION OF THE DRAWINGS

FIG. 1 shows a diagrammatic perspective view of an assembly according to the invention, installed in a vehicle, in a first position of a folding top and one possible position of a roller blind.

FIG. 2 shows the vehicle from FIG. 1, with the roller blind being in a different possible position.

FIG. 3 shows a diagrammatic sectional view of the vehicle from FIG. 1, with the folding top closed.

FIG. 4 shows the vehicle from FIG. 3, with the folding top being in a first position and the roller blind being in one possible position.

FIG. 5 shows the vehicle from FIG. 3, with the roller blind being in another possible position.

FIG. 6 shows a diagrammatic perspective illustration of a vehicle, with an assembly according to the invention installed and in a second position of the folding top.

FIG. 7 shows the vehicle from FIG. 6, with the roller blind positioned as a wind deflector.

FIG. 8 shows a diagrammatic sectional view of the vehicle from FIG. 6, with the folding top being in the second position.

FIG. 9 shows the vehicle from FIG. 8, with the roller blind positioned as a wind deflector.

FIG. 10 shows a further diagrammatic perspective view of a vehicle including an assembly according to the invention.

### DETAILED DESCRIPTION OF THE PREFERRED EMBODIMENT

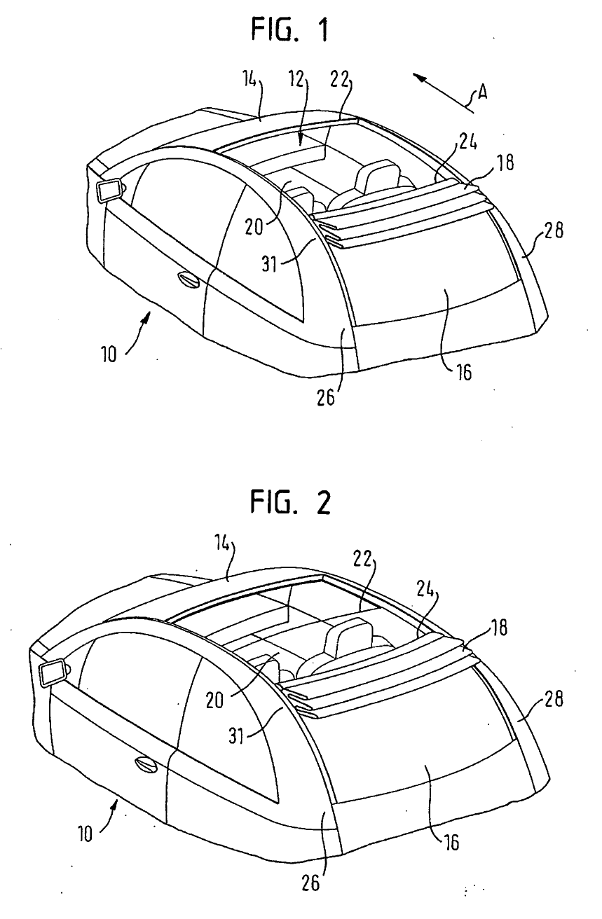

FIG. 1 shows a vehicle 10, in this case a passenger car, with a conventional stationary roof frame having a roof opening 12 formed therein. The roof opening 12 extends from an upper edge of a windshield 14 as far as a lower end 26 of a rear column 28 of the vehicle. Depending on the type of vehicle involved, the vehicle rear column 28 is one of B, C, and D columns.

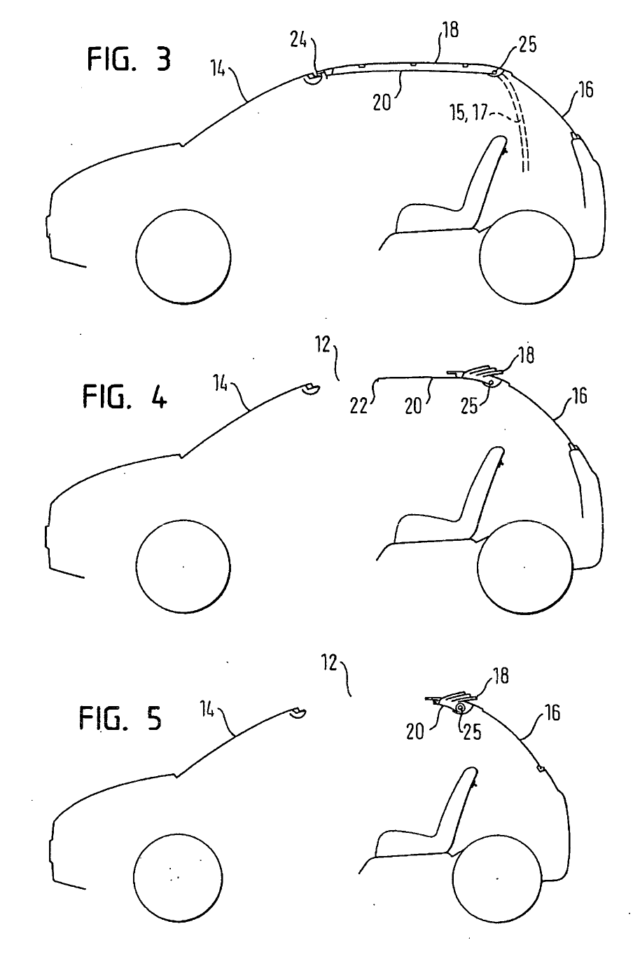

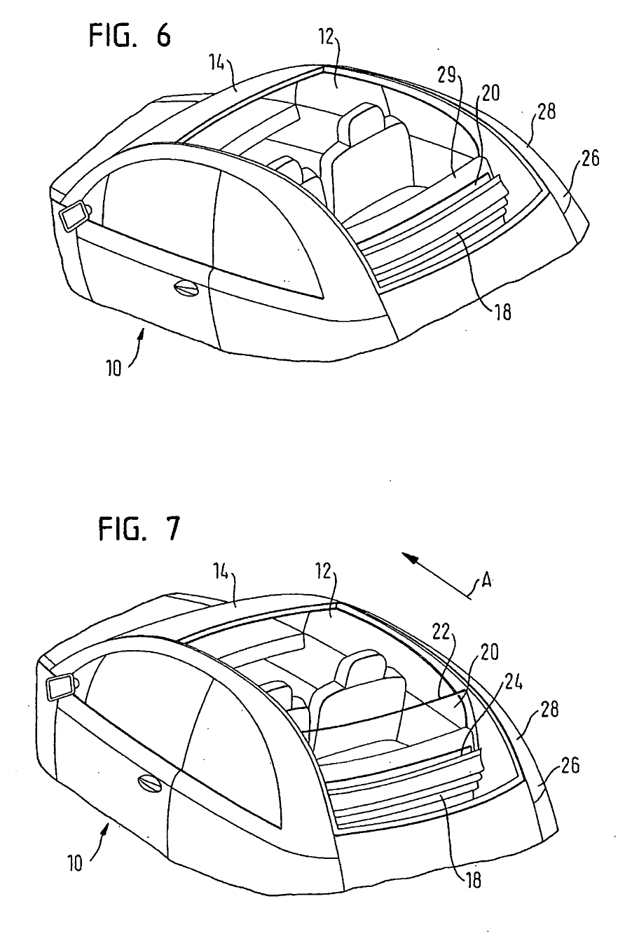

Guide rails 15 (FIGS. 3 and 10) are arranged along the roof opening 12 in a direction A towards the front of the vehicle on both sides of the roof frame and the vehicle rear column 28 (outlined in FIG. 3). A folding top 18, shown in FIG. 3 in the fully closed condition and in FIG. 6 in the fully opened condition, is guided in the guide rails 15 and is designed to completely close the roof opening 12 in the known manner. A rear end of the folding top 18 is adjoined by a rear window 16, which is formed of a transparent, flexible sheet.

Arranged beneath the folding top 18 is a roller blind 20 that runs in separate parallel guide rails 17 in a lateral guide similarly to that of the folding top 18. The guides are illustrated by way of example in FIG. 10. The guides for the folding top 18 and the roller blind 20 could also be realized in one single rail system.

The roller blind 20 assumes the function of an inner lining for the folding top 18, which is configured without an integrated inner lining itself. Viewed from an interior of the vehicle, a vehicle occupant will therefore only see the roller blind 20, and will never see an inner side of the folding top 18 or any associated linkage thereof. In order to ensure this, a mechanism of the folding top 18 and of the roller blind 20 is designed such that a front edge 22 of the roller blind 20 in the direction A must be always at least at the same level with a front edge 24 of the folding top 18. Therefore, it is ruled out that the roller blind 20 can be pushed back behind the front edge 24 of the folding top 18 counter to the direction A so that the inner side of the folding top 18 would become visible from the interior of the vehicle.

In the exposed area of the roof opening 12 between the front edge 24 of the folding top 18 and an upper end of the windshield 14, however, the roller blind 20 is movable independently of the position of the folding top 18, either manually or by an electric drive. In this way, in addition to its function as a replacement for the inner lining of the folding top 18, the roller blind 20 may also be used as a sunshade or windbreak that can be adjusted as desired.

FIGS. 3 to 5 show various possible positions of the folding top 18 and the roller blind 20 disposed underneath. When the folding top 18 is in the closed condition, the roller blind 20 is also automatically pulled completely to the front, as is shown in FIG. 3.

The folding top 18 can be pushed back along the roof frame until the folding top 18 is fully folded. In this first position, the folded folding top 18 is located at an upper end 31 of the rear column 28 (FIGS. 1 and 2) of the vehicle as viewed in FIG. 4 and FIG. 5. Below the folding top 18, the rear window 16 extends along the roof opening 12 as far as the lower end 26 of the rear column 28 of the vehicle.

In this first position of the folding top 18, the roller blind 20 can be pulled forward, for example up to the middle of the roof opening 12, in order to leave the front part of the exposed roof opening 12 open (FIG. 4). But it is also possible to push the roller blind 20 to the rear as far as the first position of the folded folding top 18, as shown in FIG. 5.

The roller blind 20 and the folding top 18 may be moved by a shared electric drive 19 or by separate electric drives (shown diagrammatically in FIG. 10).

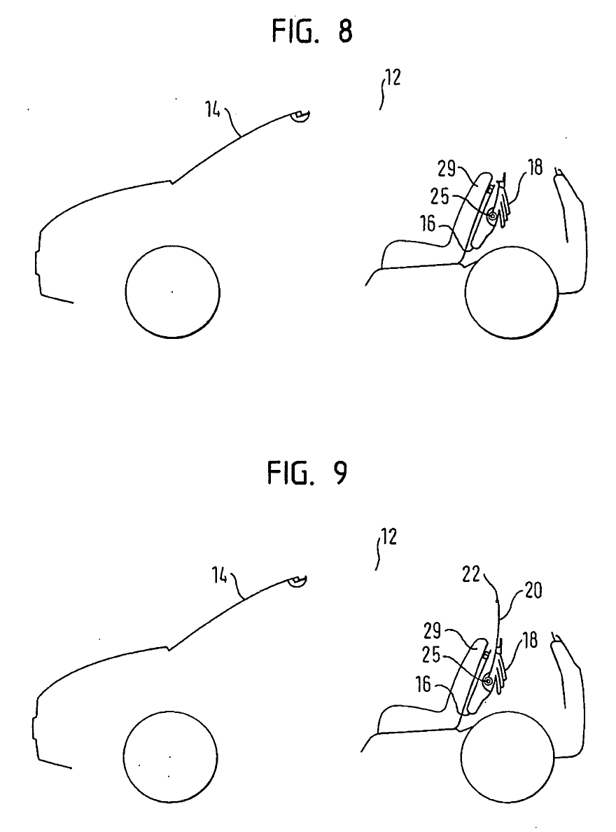

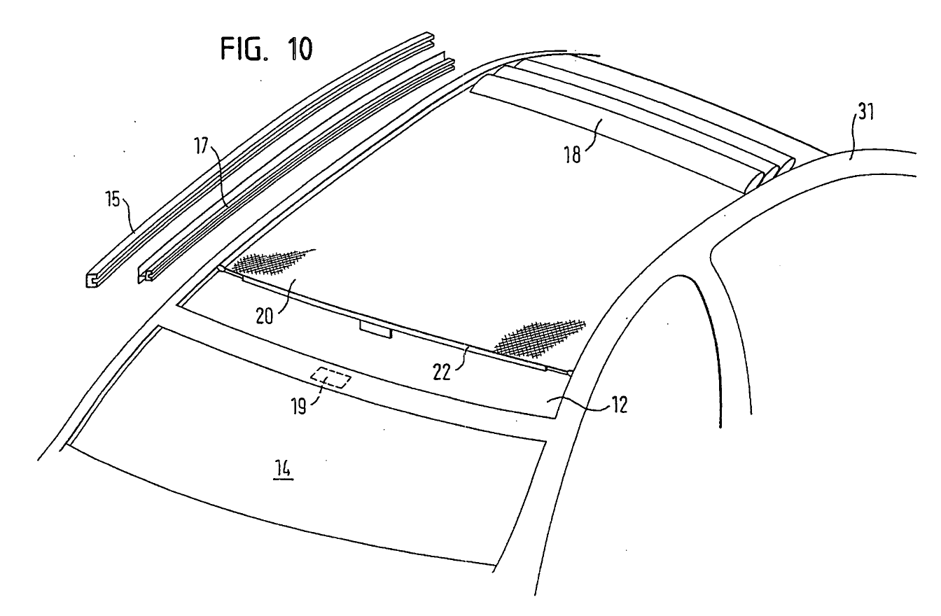

The folding top 18 and the roller blind 20 are fitted in the guide rails 15 such that the folded folding top 18 and a spindle 25 of the roller blind 20 can be moved jointly to a second position up to a level of a backrest 29 (in this case of a rear seat), as is shown in FIGS. 8 and 9.

When the assembly made up of the folded folding top 18 and the roller blind 20 has reached the second position, a lower end of the rear window 16 is released manually from a vehicle body and is attached to the backrest, for example by a conventional zip fastener system.

From this second position, the roller blind 20 can be pushed partially toward the front, independently of the folding top 18, as shown in FIGS. 7 and 9, until the roller blind 20 occupies a position of a conventional wind deflector and also takes on the function thereof. But it is also possible to shift the roller blind 20 farther across the roof opening 12 so the roller blind 20 can serve as a sunshade or windbreak.

To close the top, the procedure is reversed. First the lower end of the rear window 16 is re-fastened to the vehicle body. Then the folded folding top 18 and the roller blind 20 are moved together (electrically or manually) from the second position as far as to the first position. The roller blind 20 may now be pulled, wholly or partly, across the exposed area of the roof opening 12, while the folding top 18 remains open, i.e. folded. When the folding top 18 is closed as well, the roller blind 20 is automatically moved along in the direction A towards the front of the vehicle as soon as the front edge 24 of the folding top 18 reaches the front edge 22 of the roller blind 20. When the folding top 18 is in its fully closed condition, the roller blind 20 is always also in its closed position, in which the roller blind 20 is pulled all the way towards the front of the vehicle.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. An assembly comprising:
a vehicle folding top movable to cover or expose a roof opening; and
a roller blind that is arranged beneath the vehicle folding top when in a closed condition wherein the roller blind is adapted to at least partially cover the roof opening exposed by the vehicle folding top.

2. The assembly according to claim 1, wherein an inner side of the vehicle folding top, as viewed from an interior of a vehicle, is always covered by the roller blind.

3. The assembly according to claim 1, wherein the roller blind constitutes an inner lining for the vehicle folding top.

4. The assembly according to claim 3, wherein the vehicle folding top is configured without an integrated inner lining.

5. The assembly according to claim 1, wherein a front edge of the roller blind facing a vehicle front is always at least at a same level with a front edge of the vehicle folding top.

6. The assembly according to claim 1, wherein the roller blind can be shifted independently of the vehicle folding top across an area of the roof opening that is not covered by the vehicle folding top.

7. The assembly according to claim 1, wherein when the vehicle folding top is moved toward a closed position, the roller blind is always moved along as soon as a front edge of the vehicle folding top has reached a front edge of the roller blind in a closing direction.

8. The assembly according to claim 1, wherein the vehicle folding top and the roller blind are movable by at least one electric drive.

9. The assembly according to claim 1, wherein the roller blind is guided in a lateral guide.

10. The assembly according to claim 1, wherein the roof opening extends substantially as far as a lower end of a rear column of a vehicle.

11. The assembly according to claim 1, wherein the vehicle folding top when in a folded condition and a spindle of the roller blind are movable between a first position and a second position.

12. The assembly according to claim 11, wherein in the first position the vehicle folding top in the folded condition and the spindle of the roller blind are situated at an upper end of a rear window.

13. The assembly according to claim 11, wherein in the second position the vehicle folding top in the folded condition and the spindle of the roller blind are situated behind a backrest.

14. The assembly according to claim 1, wherein the roller blind is positionable to serve as a wind deflector.

15. The assembly according to claim 1, wherein the vehicle folding top and the roller blind are guided in separate guides.
